(19) United States
(12) Patent Application Publication
(10) Pub. No.: US 2016/0067909 A1
(43) Pub. Date: Mar. 10, 2016

(54) SURFACE STRUCTURES ON PRESS BELTS AND PRESS SHEETS

(71) Applicant: SANDVIK SURFACE SOLUTIONS DIVISION OF SANDVIK MATERIALS TECHNOLOGY, Ennepetal (DE)

(72) Inventor: Heiko PEUSTER, Wuppertal-Beyenburg (DE)

(73) Assignee: SANDVIK SURFACE SOLUTIONS DIVISION OF SANDVIK MATERIALS TECHNOLOGY, Ennepetal (DE)

(21) Appl. No.: 14/421,472

(22) PCT Filed: Aug. 12, 2013
(86) PCT No.: PCT/EP2013/066782

§ 371 Date: Oct. 7, 2015

(30) Foreign Application Priority Data
Aug. 16, 2012 (DE) 10 2012 107 526.3

(51) Int. Cl. B29C 59/02; B29C 33/42; B44C 1/22; B24C 1/04; B44B 5/02; B29C 59/04; B29C 33/38

(52) U.S. Cl. CPC B29C 59/02; B29C 59/04; B29C 33/424; B29C 33/3842; B24C 1/04; B44B 5/026; B44C 1/221; B44C 1/227; B29C 2033/0094

(57) ABSTRACT

A method for generating a structured surface of an embossing tool, in particular a press sheet or a press belt, in order to produce surface-structured panel and/or strip material, in which two or more mutually different partial surfaces are structured in mutually time-separated processing sections. Each processing section involving the following steps in the sequence as follows: masking partial surfaces that are not to be structured in the processing section, as long as they are not already masked, with a cover; removing surface material of the non-masked surface in order to produce a surface structure; optionally removing means used to structure the partial surface; and optionally removing parts of the cover or the entire cover. A pressing tool thus produced can produce imitation wooden panels, the optical effect, which comes significantly closer to the appearance of real wooden panels made with conventional pressing tools.

The invention relates to a method for producing a structured surface of a pressing tool, in particular a press plate or a press belt, in order to produce surface-structured panel material and/or strip material. The invention also relates to a pressing tool.

Surface-structured, large-format press belts (also known as continuous press belts) and press plates are used to provide substrates, such as in particular panel or strip material with a surface structure for decorative or technical purposes. Surface-structured panel or strip material is used, for example in the furniture, flooring, construction and commercial vehicle industries. The material is produced, for example from diverse plastics materials. Chipboard, plywood and MDF board are also used and are coated on the use side (upper side) or underside thereof with melamine resin-impregnated films/paper/decors. In the production of floors or commercial vehicle floors and also in the case of construction panels, a defined amount of corundum material is also added to the melamine film/paper on the use surface to provide the effective surface of the panels with the necessary abrasion resistance. For decorative applications, the surfaces of the panels are provided with decorative structures, such as wood, stone or other structures (for example pearl-shaped or finely striped surface structures, etc.). Panels for the construction and commercial vehicle industries are provided, for example with techno-geometric structures, such as rhomboid structures, wells or ribbing in order to make them slip-resistant.

Double-belt presses and heating presses are used in the production of panel material. Individual press plates with the panel to be stamped (substrate for stamping) or cassette-contained panel stacks consisting of pairs of press plates and substrate for stamping are used in the heating presses. The substrates for stamping are stamped in the presses under a defined pressure and at a defined temperature.

The pressing tools mentioned are produced by applying a structured, etch-resistant mask to the surface of the pressing tool to be structured and by subsequently etching the masked surface. The etch-resistant mask is usually printed onto the surface. After etching, the mask is removed mechanically or electrolytically and the surface is cleaned. This procedure is repeated with different structured masks until the desired final structure is obtained. The structured surface of the tool is then usually chromium-plated. This increases the service life of the tool, sets a defined gloss level of the panel surface to be produced and allows an easier removal of the panel (detachment of the pressing tool from the substrate for stamping) after stamping. The structure of the surface of the pressing tool then corresponds to the negative of the surface structure to be created on the panel material. The pressing tools are printed and etched over their entire surface in each case.

A mask can also be produced by applying a photoresist. This is carried out in that the photoresist applied to the pressing tool is covered with a film which has the desired structure and is then illuminated. In so doing, the illuminated (or the non-illuminated) parts of the photoresist cure (positive or negative photoresist coating). Following illumination, the uncured parts are chemically detached from the surface of the tool. A structured mask remains on the tool. The surface of the tool is then etched. A cleaning procedure is then carried out, as is an optional further application of another mask, followed by another etching procedure. This process is repeated with different masks until the desired final structure is obtained in the surface of the pressing tool.

When a block structure or parquet structure is to be applied to a laminate panel, this is carried out by transferring a decor paper to the laminate panel and stamping it with conventional structures (for example with a unipore structure, a pearl structure, or a hand-made paper structure).

The object of the present invention is to provide a method of the type mentioned at the outset by which it is possible to produce repetitive, different structures and by which the optical impression of the substrate for stamping can be improved.

This object is achieved according to the invention by a method having the features of claim 1.

The expression “surface of the pressing tool” is understood here and in the following as the surface of the pressing tool which is effective during the stamping of a substrate for stamping.

The expression “surface portions to be structured” is understood here and in the following as such surface portions which are contained in the total surface to be structured in the mathematical sense. When there are two or more different surface portions, at least one of said surface portions must be smaller than the total surface, i.e. it must be a proper subset of the total surface.

According to the invention, two or more of the surface portions to be structured are processed in mutually time-separated processing segments, each of the processing segments comprising the following steps in the stated sequence:
i. masking with a cover surface portions which are not to be structured in the processing segment as long as they are not already masked, as well as optionally masking parts of the surface portion to be structured;
ii. removing material and/or shaping the unmasked surface of the pressing tool to produce a surface structure;
iii. optionally removing means used for structuring the surface portion, and
iv. optionally removing parts of the cover or removing the entire cover.

The basic concept of the invention is to provide a method by which a pattern which has been divided into surface portions and has previously been depicted on a substrate for stamping with a decor paper can then be applied to the substrate by an stamping tool. The claimed method makes it possible to treat different surface portions of the surface to be structured in different ways, so that each surface portion has an independent visual effect and it appears that the substrate for stamping produced by the pressing tool consists of many individual elements corresponding to the surface portions. In this respect, it is naturally the case that the surface portion, to be structured in a processing segment, of the surface can consist of a plurality of adjacent or mutually separate parts, such as identically or comparably structured block-shaped surface portions of a parquet pattern.

In this connection, a differentiation is to be made between the surface portions which are not to be structured in a processing segment and are completely masked, and the surface portions which are to be structured in the processing segment and the surface of which can be partially covered so that it receives a structure. Here, the term “structuring” is understood as the modelling of the surface, for example the introduction of striae or cavities which are easily visible to the naked eye. To be distinguished from structuring is polishing or another processing of a surface, which serves exclusively to adjust the level of gloss of the surface, without in so doing significantly altering the shape of the surface.

The working steps within a processing segment basically comprise the steps of masking, removal of surface material of the unmasked surface and optionally the subsequent removal of means used for stripping off surface material. Depending on whether or not the processed surface portions are also to be surface-treated in a subsequent processing segment, the cover can subsequently remain on the surface or it can be completely or partly removed.

At the latest after the conclusion of all the processing segments, all the covers are removed from the surface of the pressing tool.

Covers are usually removed mechanically, preferably by a grinding and/or polishing method. At the end of the method, this processing step serves not only to remove the cover(s), but the etched structures are also rounded off and the surface is polished. However, depending on the type of mask material, as an alternative to or in addition to a grinding and/or polishing method, the cover(s) can also be removed by chemical means, by a sandblasting method or also by another suitable method.

In principle, it is possible according to the invention that the surface portions of the surface which are processed at different times, will overlap. This can be, for example an overlap over the entire surface when structures in smaller surface portions are superimposed on a previously structured larger surface portion or superimposed on the entirely structured surface of the pressing tool. A partial overlap, for example an overlap in peripheral regions of adjacent surface portions, can also be used in order to achieve particular creative effects.

In particular, when at least two of the adjacent surface portions do not overlap, clearly delimited patterns can be produced and known decors, composed of a plurality of parts, such as parquet surfaces can be imitated so that they appear deceptively genuine. If the structure extends over the entire side face of the pressing tool, it is a further advantage if the pattern is configured such that there is a seamless transition of the pattern from one side edge of the pressing tool to the opposite side edge of the pressing tool or, in the case of press plates, on one of the other sides of the pressing tool, so that substrates for stamping produced by the pressing tool can be positioned against one another, without there being a visible interruption in the pattern.

If surface portions are used in block form or in small block form, then it is possible in this manner to portray not only simple structures, for example in the form of a blockstrip design or a herringbone parquet, but also more complex and larger-area patterns extending over panels.

As previously mentioned, a preferred option of applying a structure is to mask parts of the surface portion to be structured which correspond to the pattern to be reproduced and prevent the surface material from being removed at the masked location. However, this option is not strictly necessary. It is also possible according to the invention to provide the surface portions with a differing surface roughness when the surface material is removed by different methods or method parameters, so that this also provides a surface structure.

During the masking procedure in a processing segment, a distinction is made between masking the surface portions to be structured and masking surface portions which are not to be structured insofar as the surface portions which are not to be structured are masked over their entire surface, whereas the surface portions to be structured are masked with a pattern which is necessary to produce the desired surface structure of the surface portion. However, even if the type of masking differs, it can be carried out in one working step by applying the mask onto the pressing tool per digital print. However, other methods for applying the mask are equally possible and are also preferred depending on the case of use.

Etching is particularly also considered as a preferred method for removing surface material, in which case the material of the cover used for masking must then be resistant to etching. However, electrolytic methods can also be used to remove the surface, in which case the mask must then be resistant to the electrolyte.

Sandblasting, inter alia, is considered as a preferred method for reshaping the surface, in which case in particular high-mass materials, such as small steel balls have to be used by which the surface can be compacted and dented. In this case, the material of the cover used for masking must be abrasion-resistant or pressure-resistant or must be configured such that the impulses exerted on the surface by the particles used for sandblasting do not deform the regions covered by the mask.

Sandblasting produces on the surface small craters or spherical indentations. The size and shape of the spherical indentations influences the gloss level of the sandblasted surface. If the type of materials and/or the blasting rate used for sandblasting are varied for different surface portions, the gloss level of the respective surface portions can be varied thereby, so that differently sandblasted surface portions acquire a different gloss level.

The visual effect becomes particularly effective when at least two of the surfaces to be structured separately from one another are stripped off to different depths. This can be easily realised, for example by varying the duration of stripping during etching or during an electrolytic stripping process in the different processing segments. However, alternatively or in addition, in order to achieve different etching depths in the processing segments it is also possible to use differently aggressive etchants or, in electrolytic stripping, to vary the electrolytes and/or the applied voltage used in the different processing segments. Consequently, with different surface portions, structures stamped on the substrate for stamping are produced in a different height and shape. In this manner, for example with the different block-shaped surfaces of a parquet structure, the blocks of a wood parquet can be imitated particularly effectively. The choice of etching depth can also influence the gloss level of a surface portion to be etched, so that merely the choice of different etching depths for different surface portions results in different gloss levels of these different surface portions.

In a further preferred embodiment of the method according to the invention, different patterns are masked in at least two of the surface portions to be structured separately from one another. By using different patterns, a different gloss level or reflectance of the surface portions in the substrate for stamping can be produced in the individual surface portions, so that the difference in the individual surface portions of the substrate for stamping is even more noticeable. The patterns can be selected, for example from the group of wood pore, grass structure, pearl structure and handmade paper structure. In this respect, the patterns are raised with respect to the rest of the surface so that they can be stamped later on into the substrate for stamping. The surface portions can also exhibit technical surface structures, for example for slip prevention, which do not protrude from the bottom of the surface in a raised manner on the pressing tool, but are introduced into the bottom of the surface so that they are raised in the substrate for stamping.

The choice of one or more patterns for a surface portion has a direct influence on the gloss level of the corresponding surface portions of the substrate for stamping to be produced by the pressing tool. Thus, a wood pore etched at one level (unipore) can be effectively buffed mechanically, because a grinding or polishing belt running in the longitudinal direction of the pore (for example a microlon grinding belt) engages very effectively into the subsurface of the wood pore oriented lengthways and brightens the bottom of the surface. If the wood pore pattern is combined with a grass structure so that the open spaces between the longitudinally oriented pores are greatly reduced, it becomes significantly more difficult to polish the subsurface. The gloss level of the etched bottom of the surface is then significantly lower, in particular because the reflecting face of the surface bottom has been effectively interrupted in the longitudinal direction. The gloss level in the case of a pearl structure is usually the lowest, since the pearl structure interrupts the surface bottom in all directions, so that the glossy open space at the bottom of the surface is interrupted in all directions. Furthermore, it is difficult for the grinding or polishing belt to reach the bottom of the surface.

It is basically true that for coarser, direction-dependent structures, such as a wood pore structure, the light refraction is direction-dependent and rather low so that the gloss level of the surface is not greatly reduced thereby, and it is also true that for finer structures, the light diffraction is greater and fairly directionless, so that the gloss level is reduced to a greater extent thereby. To adapt the influence of a pattern on the gloss level, the pattern can be scaled, an enlargement of the pattern generally resulting in a higher gloss level and a diminishment of the pattern resulting in a lower gloss level. The surface portions to be structured can be respectively removed at one level but also at multiple levels.

In addition to the above-mentioned possibility of applying the covers in a processing segment by a printing method, it can be advantageous if the mask for the surface portions which are not to be structured is applied as a film. In this respect, the recesses for the surface portions to be structured can already be made in the film before it is applied to the surface. Alternatively, the film can be applied over the entire surface of the press plate and the surface portions to be structured can then be cut out of the film, for example using a template. The cover for the surface, not to be removed, of the surface portion to be structured which is required to produce the structure can then be applied, in particular imprinted, as a lacquer or wax.

The invention is also realised by a pressing tool having the features of claim 14.

According to the invention, the pressing tool has a surface with two or more mutually different, structured surface portions. The surface portions can particularly differ from one another in that their surface bottom is not located in different planes, which are preferably offset relative to one another within a range of 5 to 100 μm, and/or in that the surface portions have a differing surface structure.

In the following, the method according to the invention will be described in more detail on the basis of an example of a method for producing a press plate for the production of surface structures in laminate floorings or laminated panels, which is an example of all previously described characteristics and features of the [. . . ] according to the invention.

The press plate allows the production of a three-block design. Here, the term “three block” denotes a typical blockstrip design (three wood blocks per laminate panel next to one another, offset relative to one another in the longitudinal direction).

In a first step, a wood pore image is applied as a mask over the entire surface of the press plate to be structured. The etch-resistant cover acting as a mask can be printed on, for example by screen printing, indirect intaglio printing or digital printing. The image can also be illuminated on the press plate surface to be structured, if the surface has previously been fully coated with a UV varnish or with a lithography film. The parts of the lithography film or UV varnish which have not cured during illumination can then be removed so that the cured parts remain on the surface as a mask. Thereafter, the surface of the press plate to be structured is etched with a structure depth of, for example 120 μm. After etching, the cover is removed mechanically, for example using a microlon-coated grinding belt, and the press plate is prepared for the next masking procedure.

In a second step, individual blocks of the three-block design to be produced are to be additionally provided in a specific manner with a grass pore design. For this purpose, the entire surface of the press plate, with the exception of the surface portion to be structured, is masked for the depiction of the block. A precisely cut-out, etch-resistant film can be affixed for masking. Likewise, the measures stated with regard to the first step can be used for masking. As a result, the cover produced thus only leaves defined regions free which can be provided individually with a structure. An etch-resistant image, corresponding to the grass pore structure is applied to these free regions. Methods particularly considered for this procedure are those which can also be used in the first step. The masked surface of the press plate is then etched. Here, the etching depth is, for example 70 μm. After etching, the film and masking are removed mechanically by a grinding method (for example microlon grinding) and the plate is prepared for the next step.

In a third step, other blocks of the three-block design to be produced are to be additionally provided in a specific manner with a pearl structure. For this purpose, the surface of the press plate is covered, with the exception of surface portions to be structured corresponding to the “other” blocks. An etch-resistant image, corresponding to the pearl structure, is then applied to the defined free regions. Finally, the masked surface of the press plate is etched again. This time, the etching depth is for example 40 μm. The previously described methods are considered as methods for masking, for applying an image corresponding to the structure to be applied and for etching. In the described example, this is the last etching procedure.

A subsequent grinding treatment (for example microlon grinding again) not only serves to remove the masking, but also rounds off the etched structures and polishes the press plate.

Finally, the press plate is sandblasted at a low blasting pressure, dulled and then chromium-plated.

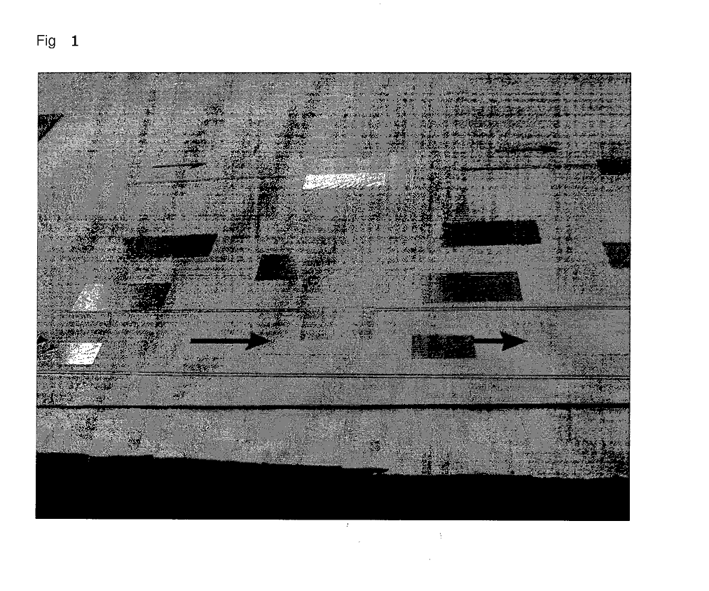

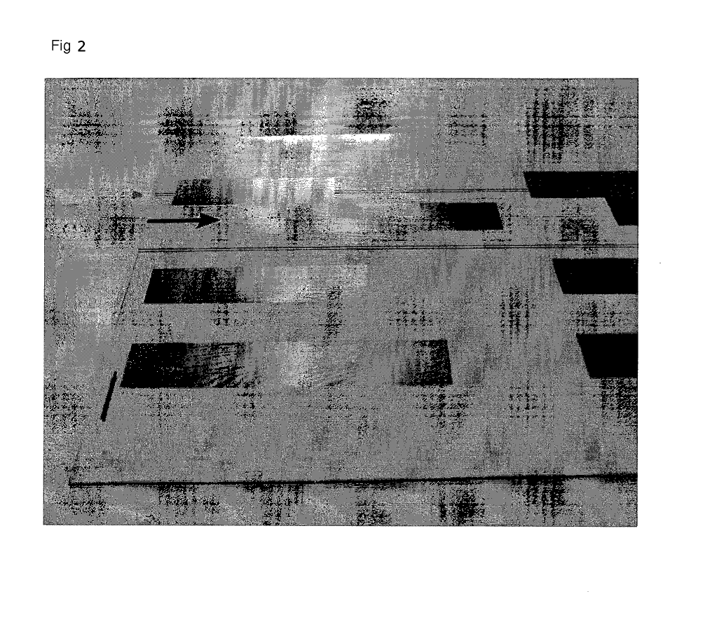

FIGS. 1 and 2 show how a press plate which already has a full-surface wood pore structure is provided in each case with a film by adhesive bonding for the second and third processing segments, out of which film the surface portions to be processed for the respective processing segment are cut and exposed.

The three-stage method which has been described produces a press plate having a repetitive three-block pattern, in which some of the blocks are structured exclusively with a wood pore pattern, other blocks have a grass pore structure in addition to the wood pore pattern and third blocks have a pearl structure on their surface in addition to the wood pore pattern. The bottom of the surface of each of the three different types of block is located in a different plane, the surface bottom of the blocks with a wood pore/grass pore pattern being 70 μm deeper than the surface bottom of the blocks with a simple wood pore pattern, and the surface bottom of the blocks with a wood pore/pearl structure being 40 μm deeper than the surface bottom of the blocks with a simple wood pore pattern. Thus, the blocks of the three-block design of a substrate for stamping produced by the press plate are also located in different planes.

The multi-part nature of the three-block design becomes optically visible on the one hand due to these different planes. The multi-part nature of the three-block design also becomes visually detectable in that the gloss level of the different block surfaces is significantly different because, as described above, the surface bottom of the individual block surfaces is polished with differing effectiveness subject to the surface structure. Furthermore, the multi-part nature of the three-block design becomes visually perceptible in that the reflecting open spaces are interrupted to a different extent by the respective structures. The differing reflection of the individual types of block corresponds, for example to the different reflection of differently grained blocks of a real wood floor.

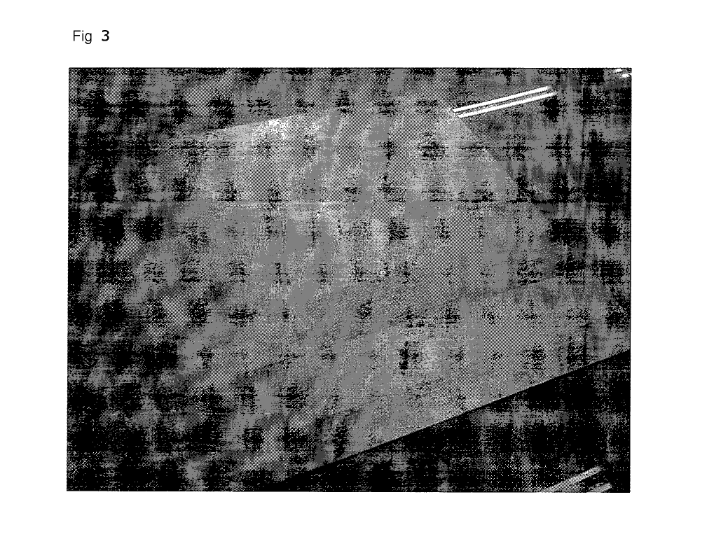

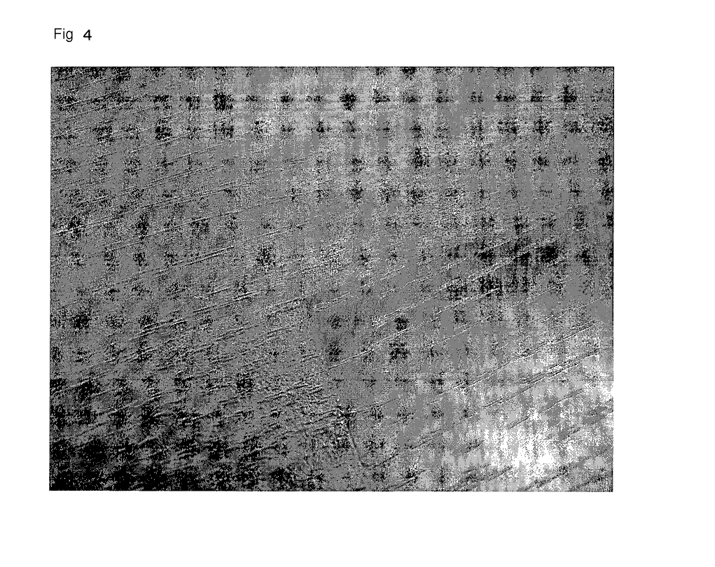

FIG. 3 shows the press plate produced by the three-stage method and FIG. 4 shows a detail of the surface thereof. It can be seen particularly clearly in FIG. 3 that the surface portions have a differing gloss level and they reflect light differently. Furthermore, FIG. 4 shows the different patterns of the surface portions as well as the different levels thereof. Thus, the bottom right surface portion is the surface which has only been structured with a wood pore structure, the surface portion positioned above is the surface in which a grass pore structure has been superimposed on the wood pore structure and the bottom left surface portion is the surface in which a pearl structure has been superimposed on the wood pore pattern.

As a result, using the method according to the invention, it is possible to produce a pressing tool for creating an imitation wood floor which more closely resembles a corresponding wood floor than was previously the case with previous tools for the production of laminate floors.

Even during pressing with a unipaper (for example black), a pressing tool structured by this method provides such a realistic character that the end product actually looks like a black varnished real wood floor. Using the pressing tool according to the invention, it is possible to employ many varied decor papers without the true-to-nature impression of the substrate for stamping being impaired.

The described method for structuring the surface of the pressing tool can be used accordingly to produce a plurality of superficial patterns. The number of surface portions to be structured individually and the number of patterns or removal levels used per surface portion can be selected as desired. Each partial structure can have its very own structure, but the different surface portions can also have one or more combined common surface structures and it is possible for them to differ from one another only in the combination with an additional pattern (as in the described embodiment).

1. A method for producing a structured surface of a pressing tool, such as a press plate or a press belt, to produce surface-structured panel material and/or strip material, wherein two or more mutually different surface portions are structured in mutually time-separated processing segments, each of the processing segments comprising the steps of:
full-surface masking surface portions which are not to be structured in the processing segment and not already masked with a cover, and optionally masking parts of the surface portion to be structured;
removing material and/or shaping an unmasked surface to produce a surface structure;
optionally removing a means used for structuring the surface portion; and
optionally removing parts of the cover or removing the entire cover.

2. Method The method according to claim 1, wherein some of the surface portions which are processed in a time-separated manner at least partly overlap.

3. The method according to claim 1, wherein all of the surface portions which are processed in a time-separated manner do not overlap.

4. The method according to claim 1, wherein the step of removing the material and/or shaping the unmasked surface comprises etching the surface portion to be structured, the cover being etch-resistant.

5. The method according to claim 1, wherein the step of removing the material and/or shaping the unmasked surface comprises sandblasting the surface portion to be structured, the cover being abrasion-resistant or pressure-resistant.

6. The method according to claim 1, wherein one or more of the surface portions to be structured separately in time are block-shaped and together display a parquet structure, selected from a form of a blockstrip design, a herringbone parquet or a cassette flooring.

7. The method according to claim 1, wherein the surface of at least two of the surface portions to be structured in mutually time-separated processing segments are stripped to different depths.

8. The method according claim 1, wherein different patterns are masked in at least two of the surface portions to be structured in mutually time-separated processing segments.

9. The method according to claim 8, wherein the etching patterns are selected from the group of wood pore, grass structure, pearl structure and handmade paper structure.

10. The method according to claim 7, wherein at least one of the surface portions is stripped in a multi-level manner.

11. The method according to claim 1, wherein a film is used to mask surface portions which are not to be structured.

12. The method according to claim 1, wherein a lacquer and/or a wax is used and is printed on in particular for masking superficial parts to be structured.

13. A pressing tool, such as a press plate or press belt, for producing structures on a substrate surface, such as a laminate floor surface or on a laminated panel surface, comprising a surface having two or more mutually different, structured surface portions.

14. The pressing tool according to claim 13, wherein at least two of the structured surface portions have a surface bottom in different planes.

15. The pressing tool according to claim 13, wherein at least two of the surface portions have a different surface structure.
